(19) United States
(12) Patent Application Publication
(10) Pub. No.: US 2025/0212838 A1
(43) Pub. Date: Jul. 3, 2025

(54) Pet and Human Tricycle Device

(71) Applicant: Apryll Cecil, Paonia, CO (US)

(72) Inventor: Apryll Cecil, Paonia, CO (US)

(21) Appl. No.: 19/007,757

(22) Filed: Jan. 2, 2025

Related U.S. Application Data
(60) Provisional application No. 63/616,938, filed on Jan. 2, 2024.

(51) Int. Cl. A01K 1/02; B62K 5/06; B62K 27/10; B62M 6/10; B62M 6/40; B62M 25/00

(52) U.S. Cl. CPC A01K 1/0281; B62K 5/06; B62K 27/10; B62M 6/10; B62M 6/40; B62M 25/00

(57) ABSTRACT

A pet and human tricycle device is provided. The device is comprised of a tricycle comprised of a secondary frame. The secondary frame is comprised of a rotating belt that can be used as a manual treadmill for a pet to run alongside the user while the user pedals the tricycle. The pet can further be secured to the secondary frame during use. The device is self-propelled by the pet such that the pet can run at its own pace, and wherein rotation of the belt can be inhibited by the user as desired via at least one mechanism.

### CROSS-REFERENCE TO RELATED APPLICATION

The present application claims priority to, and the benefit of, U.S. Provisional Application No. 63/616,938, which was filed on Jan. 2, 2024, and is incorporated herein by reference in its entirety.

### FIELD OF THE INVENTION

The present invention relates generally to the field of tricycles. More specifically, the present invention relates to a pet and human tricycle device comprised of a tricycle comprised of a secondary frame with a rotating belt that a pet can be attached to and run on while the device is being pedaled by a user. Accordingly, the present disclosure makes specific reference thereto. Nonetheless, it is to be appreciated that aspects of the present invention are also equally applicable to other like applications, devices, and methods of manufacture.

### BACKGROUND

Many individuals find pleasure in engaging in outdoor activities with their pets, particularly taking their dogs or other pets out for a brisk run while they ride on a bicycle. This shared activity not only promotes physical exercise but also strengthens the bond between pet owners and their animals, offering both, a refreshing change from routine walks.

However, despite its apparent benefits, this form of exercise is not devoid of risks. Specifically, this activity can quickly become hazardous if the pet is unable to maintain the pace set by the bicycle. This disparity in speed can lead to exhaustion or injury for the pet, as they might overexert themselves in an attempt to keep up. Moreover, the situation can escalate to danger if the bicycle swerves unexpectedly. Such sudden movements can cause accidents, potentially injuring both the pet and the owner.

The risks are particularly acute in busy or unpredictable environments where external factors such as traffic, other animals, or pedestrians can prompt unforeseen swerves. Thus, while the idea of cycling with pets offers an attractive avenue for exercise and bonding, it demands careful consideration and preparation to mitigate these inherent risks, ensuring the safety and well-being of all involved.

Therefore, there exists a long-felt need in the art for a device that allows a user to safely ride a vehicle while also accompanied by a pet. There also exists a long-felt need in the art for a pet and human tricycle device. More specifically, there exists a long-felt need in the art for a pet and human tricycle device that allows a pet to run alongside a human riding on the tricycle. Further, there exists a long-felt need in the art for a pet and human tricycle device that allows a pet to run alongside a human riding on the tricycle while the pet remains safe and can run at its own pace.

The subject matter disclosed and claimed herein, in one embodiment thereof, comprises a pet and human tricycle device. The device is comprised of a tricycle comprised of a secondary frame. The secondary frame is comprised of a rotating belt that can be used as a manual treadmill for a pet to run alongside the user while the user pedals the tricycle. The pet can further be secured to the secondary frame during use. The device is self-propelled by the pet such that the pet can run at its own pace, and wherein rotation of the belt can be inhibited by the user as desired via at least one mechanism.

In this manner, the pet and human tricycle device of the present invention accomplishes all the foregoing objectives and provides a device that allows a user to safely ride a vehicle while also accompanied by a pet. More specifically, the device allows a pet to run alongside a human riding on the tricycle. While doing so, the device ensures the pet remains safe and can run at its own pace while attached to the tricycle.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pet and human tricycle device comprised of a tricycle that is comprised of an attached frame and belt that allows a dog (or other animal) to run alongside a user who is pedaling the device.

The device is comprised of a plurality of features commonly found on tricycles. In one embodiment, a user can manually pedal the device in order to propel the device. In another embodiment, the device is comprised of at least one motor that assists a user with pedaling. The motor may include, but is not limited to, a rechargeable electric motor, a gas motor, etc.

The frame is also comprised of a secondary frame comprised of at least one side wall. At least one side wall is comprised of at least one attachment point that allows a pet harness/leash to attach to the frame to secure a pet to the frame. After being secured, a pet can run on a belt that rotates around at least one rotation point in a manner similar to a manual treadmill. This allows a pet to walk, jog, run, etc., while the user pedals and steers the device.

As a result, the user need not worry about the pet encountering any obstructions while walking, jogging, running, etc. The device may also be comprised of at least one mechanism that can be engaged to prevent rotation of the belt. The mechanism may be located anywhere on the device that can be operated by the user while using the device.

The present invention is also comprised of a method of using the device. First, a device is provided comprised of a tricycle frame comprised of at least three wheels, at least two pedals, at least one drive mechanism, and at least one secondary frame comprised of at least three side walls, at least one belt, and at least one rotation point. Then, a user can place a pet onto the belt and secure a pet's harness, leash, etc., to at least one side wall via an attachment point of at least one side wall. Then, a user can pedal and steer the device as desired while the pet can walk, run, or jog on the belt securely and safely.

The present invention is also comprised of a second method of using the device. First, a device is provided comprised of a tricycle frame comprised of at least three wheels, at least two pedals, at least one motor, at least one drive mechanism, and at least one secondary frame comprised of at least three side walls, at least one belt, and at least one rotation point. Then, a user can place a pet onto the belt and secure a pet's harness, leash, etc., to at least one side wall via an attachment point of at least one side wall. Then, a user can pedal and steer the device as desired while selecting a pedal assist mode of the motor to allow the motor to aid in pedaling the device. Then, the pet can walk, run, or jog on the belt securely and safely.

Accordingly, the pet and human tricycle device of the present invention is particularly advantageous as it provides a device that allows a user to safely ride a vehicle while also being accompanied by a pet. More specifically, the device allows a pet to run alongside a human riding on the tricycle. While doing so, the device ensures the pet remains safe and can run at its own pace while attached to the tricycle. In this manner, the pet and human tricycle device overcomes the limitations of existing devices and methods used to walk a pet while riding a vehicle known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a pet and human tricycle device of the present invention in accordance with the disclosed architecture;

FIG. 2 illustrates a rear perspective view of one potential embodiment of a pet and human tricycle device of the present invention in accordance with the disclosed architecture;

FIG. 3 illustrates a flowchart of a method of using one potential embodiment of a pet and human tricycle device of the present invention in accordance with the disclosed architecture; and

FIG. 4 illustrates a flowchart of a method of using one potential embodiment of a pet and human tricycle device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a user to safely ride a vehicle while also accompanied by a pet. There also exists a long-felt need in the art for a pet and human tricycle device. More specifically, there exists a long-felt need in the art for a pet and human tricycle device that allows a pet to run alongside a human riding on the tricycle. Further, there exists a long-felt need in the art for a pet and human tricycle device that allows a pet to run alongside a human riding on the tricycle while the pet remains safe and can run at its own pace.

The present invention, in one exemplary embodiment, is comprised of a pet and human tricycle device. The device is comprised of a tricycle that is comprised of an attached frame and belt that allows a dog (or other animal) to run alongside a user who is pedaling the device.

Further, the device is comprised of a plurality of features commonly found on tricycles. In one embodiment, a user can manually pedal the device in order to propel the device. In another embodiment, the device is comprised of at least one motor that assists a user with pedaling, wherein the motor may include, but is not limited to, a rechargeable electric motor, a gas motor, etc.

The frame is also comprised of a secondary frame comprised of at least one side wall comprised of at least one attachment point that allows a pet harness/leash to attach to the frame to secure a pet to the frame. After being secured, a pet can run on a belt that rotates around at least one rotation point in a manner similar to a manual treadmill. This allows a pet to walk, jog, run, etc., while the user pedals and steers the device.

As a result, the user need not worry about the pet encountering any obstructions while walking, jogging, running, etc. The device may also be comprised of at least one mechanism that can be engaged to prevent rotation of the belt. The mechanism may be located anywhere on the device that can be operated by the user while using the device.

The present invention is also comprised of a method of using the device. First, a device is provided comprised of a tricycle frame comprised of at least three wheels, at least two pedals, at least one drive mechanism, and at least one secondary frame comprised of at least three side walls, at least one belt, and at least one rotation point. Then, a user can place a pet onto the belt and secure a pet's harness, leash, etc., to at least one side wall via an attachment point of at least one side wall. Then, a user can pedal and steer the device as desired while the pet can walk, run, or jog on the belt securely and safely.

The present invention is also comprised of a second method of using the device. First, a device is provided comprised of a tricycle frame comprised of at least three wheels, at least two pedals, at least one motor, at least one drive mechanism, and at least one secondary frame comprised of at least three side walls, at least one belt, and at least one rotation point. Then, a user can place a pet onto the belt and secure a pet's harness, leash, etc., to at least one side wall via an attachment point of at least one side wall. Then, a user can pedal and steer the device as desired while selecting a pedal assist mode of the motor to allow the motor to aid in pedaling the device. Then, the pet can walk, run, or jog on the belt securely and safely.

Accordingly, the pet and human tricycle device of the present invention is particularly advantageous as it provides a device that allows a user to safely ride a vehicle while also being accompanied by a pet. More specifically, the device allows a pet to run alongside a human riding on the tricycle. While doing so, the device ensures the pet remains safe and can run at its own pace while attached to the tricycle. In this manner, the pet and human tricycle device overcomes the limitations of existing devices and methods used to walk a pet while riding a vehicle known in the art.

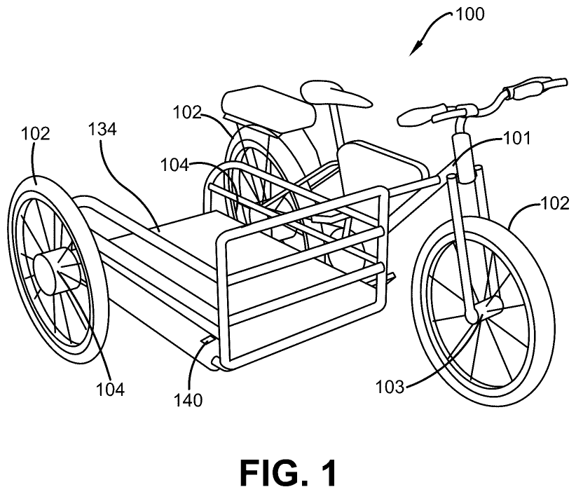

Referring initially to the drawings, FIG. 1 illustrates a front perspective view of one potential embodiment of a pet and human tricycle device of the present invention in accordance with the disclosed architecture. The device 100 is comprised of a tricycle that is comprised of an attached frame 130 and belt 134 that allows a dog (or other animal) to run alongside a user who is pedaling the device 100.

The device 100 is comprised of a plurality of features commonly found on tricycles, such as, but not limited to, at least three wheels 102 (of any type), a front axle 103, a rear axle 104, at least one pedal 105, at least one chain 106 that attaches to at least one drive mechanism 107, at least one adjustable seat 108, a pair of handlebars 109, at least one brake lever 110, in one embodiment—at least one gear shifter 111, and at least one removable storage bag/compartment 112.

In one embodiment, a user can manually pedal the device 100 in order to propel the device. In another embodiment, the device 100 is comprised of at least one motor 120 that assists a user with pedaling. The motor 120 may include, but is not limited to, a rechargeable electric motor, a gas motor, etc. In an electric embodiment, the motor 120 may be comprised of a battery 122 that may be removable or non-removable and is preferably rechargeable. The battery 122 may be recharged via at least one charging port 124 of any type. The motor 120 may have a plurality of pedal assist levels that can be selected via at least one button 126 that range from no assist to full assist (which requires no pedaling from the user).

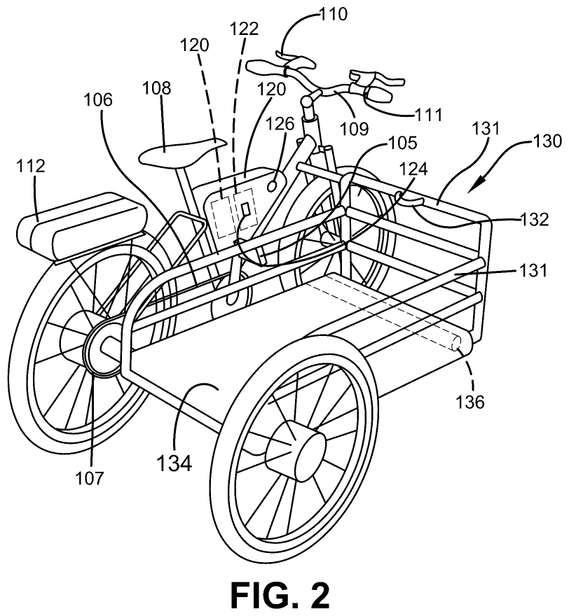

The frame 101 is also comprised of a secondary frame 130. The frame 130 is preferably generally square or rectangular shaped but may be any shape. The frame 130 is comprised of at least one side wall 131. At least one side wall 131 is comprised of at least one attachment point 132 (as seen in FIG. 2) that allows a pet harness/leash to attach to the frame 130 to secure a pet to the frame 130. After being secured, a pet can run on a belt 134 that rotates around a perimeter of at least one rotation point 136 in a manner similar to a manual treadmill. This allows a pet to walk, jog, run, etc., while the user pedals and steers the device 100. As a result, the user need not worry about the pet encountering any obstructions while walking, jogging, running, etc. The device 100 may also be comprised of at least one mechanism 140 that can be engaged to prevent rotation of the belt 134. The mechanism 140 may be located anywhere on the device 100 that can be operated by the user while using the device 100.

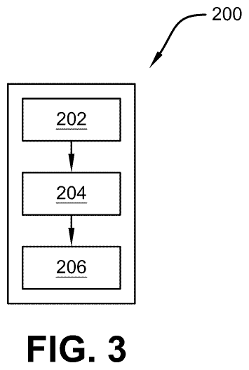

The present invention is also comprised of a method of using 200 the device 100, as seen in FIG. 3. First, a device 100 is provided comprised of a tricycle frame 101 comprised of at least three wheels 102, at least two pedals 105, at least one drive mechanism 107, and at least one secondary frame 130 comprised of at least three side walls 131, at least one belt 134, and at least one rotation point 136 [Step 202]. Then, a user can place a pet onto the belt and secure a pet's harness, leash, etc., to at least one side wall 131 via an attachment point 132 of at least one side wall [Step 204]. Then, a user can pedal and steer the device 100 as desired while the pet can walk, run, or jog on the belt 134 in a secured and safe manner [Step 206].

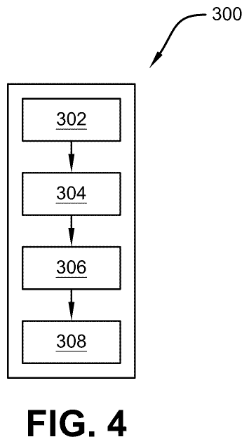

The present invention is also comprised of a second method of using 300 the device 100, as seen in FIG. 4. First, a device 100 is provided comprised of a tricycle frame 101 comprised of at least three wheels 102, at least two pedals 105, at least one motor 120, at least one drive mechanism 107, and at least one secondary frame 130 comprised of at least three side walls 131, at least one belt 134, and at least one rotation point 136 [Step 302]. Then, a user can place a pet onto the belt and secure a pet's harness, leash, etc., to at least one side wall 131 via an attachment point 132 of at least one side wall [Step 304]. Then, a user can pedal and steer the device 100 as desired while selecting a pedal assist mode of the motor 120 to allow the motor 120 to aid in pedaling the device 100 [Step 306]. Then, the pet can walk, run, or jog on the belt 134 in a secured and safe manner [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pet and human tricycle device” and “device” are interchangeable and refer to the pet and human tricycle device 100 of the present invention.

Notwithstanding the foregoing, the pet and human tricycle device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the pet and human tricycle device 100 as shown in the FIGS. are for illustrative purposes only, and that many other sizes and shapes of the pet and human tricycle device 100 are well within the scope of the present disclosure. Although the dimensions of the pet and human tricycle device 100 are important design parameters for user convenience, the pet and human tricycle device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet and human tricycle device comprising:
a tricycle comprised of a frame;
a secondary frame attached to the frame, the secondary frame comprised of a side wall;
a belt; and
a rotation point.

2. The pet and human tricycle device of claim 1 further comprised of a motor.

3. The pet and human tricycle device of claim 2, wherein the motor is comprised of an electric motor.

4. The pet and human tricycle device of claim 1, wherein the belt rotates around a perimeter of the rotation point.

5. The pet and human tricycle device of claim 4, wherein rotation of the belt can be inhibited by a mechanism.

6. The pet and human tricycle device of claim 1, wherein the tricycle is comprised of a wheel.

7. The pet and human tricycle device of claim 1, wherein the tricycle is comprised of a drive mechanism.

8. The pet and human tricycle device of claim 1, wherein the tricycle is comprised of a gear shifter.

9. A pet and human tricycle device comprising:
a tricycle comprised of a frame;
a secondary frame attached to the frame, the secondary frame comprised of a side wall and an attachment point;
a belt; and
a rotation point.

10. The pet and human tricycle device of claim 9 further comprised of a motor.

11. The pet and human tricycle device of claim 10, wherein the motor is comprised of a gas motor.

12. The pet and human tricycle device of claim 9, wherein the belt rotates around a perimeter of the rotation point.

13. The pet and human tricycle device of claim 12, wherein rotation of the belt can be inhibited by a mechanism.

14. The pet and human tricycle device of claim 9, wherein the tricycle is comprised of a wheel.

15. The pet and human tricycle device of claim 9, wherein the tricycle is comprised of a drive mechanism.

16. The pet and human tricycle device of claim 9, wherein the tricycle is comprised of a gear shifter.

17. A method of using a pet and human tricycle device, the method comprising the following steps:
providing a pet and human tricycle device comprised of a tricycle frame comprised of a wheel, a pedal, a drive mechanism, and a secondary frame comprised of a side wall, a belt, and a rotation point;
placing a pet onto the belt and securing a pet to the side wall via an attachment point of the side wall; and
pedaling and steering the pet and human tricycle device while a pet can walk, run, or job on the belt.

18. The method of using a pet and human tricycle device of claim 17, wherein the pet and human tricycle device is comprised of a motor.

19. The method of using a pet and human tricycle device of claim 17, wherein the belt rotates around a perimeter of the rotation point.

20. The method of using a pet and human tricycle device of claim 19, the pet and human tricycle device is comprised of a mechanism that stops the rotation of the belt.
